(19) United States
(12) Patent Application Publication
(10) Pub. No.: US 2004/0246825 A1
(43) Pub. Date: Dec. 9, 2004

(54) Optical compact disk and portable optical compact disk drive adopted for the optical compact disk

(76) Inventor: Yu-Nung Shen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/853,213

(22) Filed: May 26, 2004

(30) Foreign Application Priority Data
Jun. 6, 2003 (TW) 92210358

(51) Int. Cl. G11B 7/085

(52) U.S. Cl. 369/30.27; 369/30.75

(57) ABSTRACT

A portable optical compact disk drive has a casing, a tray, an image capture unit and a control circuit. The casing has a tray-receiving cavity formed therein. The tray is capable of be accepted in the tray-receiving cavity via a free end of the casing, and, alternatively, being ejected from and placed into the casing. The tray has a disk-receiving window formed therein to carry the optical compact disk. The image capture unit is arranged in the casing, and records data stored on the surface of the optical compact disk loaded in the tray, while the tray is located in the tray-receiving cavity. The control circuit electrically connects the image capture unit to receive image information, and is capable of decoding the image information and transmitting the decoded image information to the peripheral circuit.

### BACKGROUND OF THE INVENTION

1. Field of the Invention

The present invention relates to an optical compact disk drive. The invention relates also to an optical compact disk and a portable optical compact disk drive adopted for the optical compact disk.

2. Background of the Invention

The conventional optical compact disk is progressively taking the place of the floppy disk due to the high data storage and low price thereof. Even so, the conventional optical compact disk has a size so much larger than that of the floppy disk that it lacks portability and convenience. A kind of memory device, known as a “flash disk”, with a small size is provided as another choice. The flash disk is popular because of a thumb-like size for carrying easily and a 32MB data storage capacity thereof. But the flash disk is more expensive and less popular than the floppy disk or the conventional optical compact disk. Hence, an improvement over the prior art is required to overcome the disadvantages thereof.

### SUMMARY OF INVENTION

The present invention has been accomplished under the circumstances in view. It is therefore the main object of the present invention to provide a portable optical compact disk and a portable optical compact disk drive that can read the portable optical compact disk.

According to the present invention, an optical compact disk is provided and includes a thumb-like size and a surface that has a plurality of equidistant lands parallel to one another for storage capacity.

According to the present invention, a portable optical compact disk drive is provided and includes a casing, a tray, an image capture unit and a control circuit. The casing has a tray-receiving cavity formed therein. The tray is accepted in the tray-receiving cavity via a free end of the casing, and ejected from and placed into the casing, alternatively. The tray has a disk-receiving window formed therein to carry the optical compact disk. The image capture unit is arranged in the casing, and records data stored on the surface of the optical compact disk loaded in the tray while the tray is accepted in the tray-receiving cavity. The control circuit electrically connects to the image capture unit to receive image information, and is capable of decoding the image information and transmitting the decoded image information to the peripheral circuit.

According to the present invention, the tray is receivable in a conventional tray of a conventional optical compact disk drive, and includes at least a cavity that accepts the optical compact disk as mentioned above.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a top view of a portable optical compact disk drive according to a first embodiment of the present invention;

FIG. 2 is a simplified functional block diagram of the portable optical compact disk drive according to the first embodiment of the present invention;

FIG. 3 is a perspective view of the portable optical compact disk drive according to the first embodiment of the present invention;

FIG. 4 is an outline of part of a tray orientation mechanism according to the first embodiment of the present invention;

FIG. 5 is a perspective view of a converging member according to the first embodiment of the present invention;

FIG. 6 is a perspective view of the converging member in another type according to the first embodiment of the present invention;

FIG. 7 is a top view of a light source of an image capture unit according to the first embodiment of the present invention;

FIG. 8 is an outline of the tray orientation mechanism in another type according to the first embodiment of the present invention;

FIG. 9 is a simplified functional block diagram of the image capture unit in another type according to the first embodiment of the present invention;

FIG. 10 is a top view of image capture unit according to FIG. 9;

FIG. 11 is a top view of the portable optical compact disk drive according to a second embodiment of the present invention;

FIG. 12 is a top view of a tray that can be loaded with a plurality of optical compact disks according to the present invention and is adopted for a connectional tray; and

FIG. 13 is a top view of the optical compact disk according to the present invention arranged on a credit card according to another embodiment of the present invention.

For ease of description of connections between elements, the drawings are not drawn in proportion.

### DETAILED DESCRIPTION OF THE EMBODIMENTS

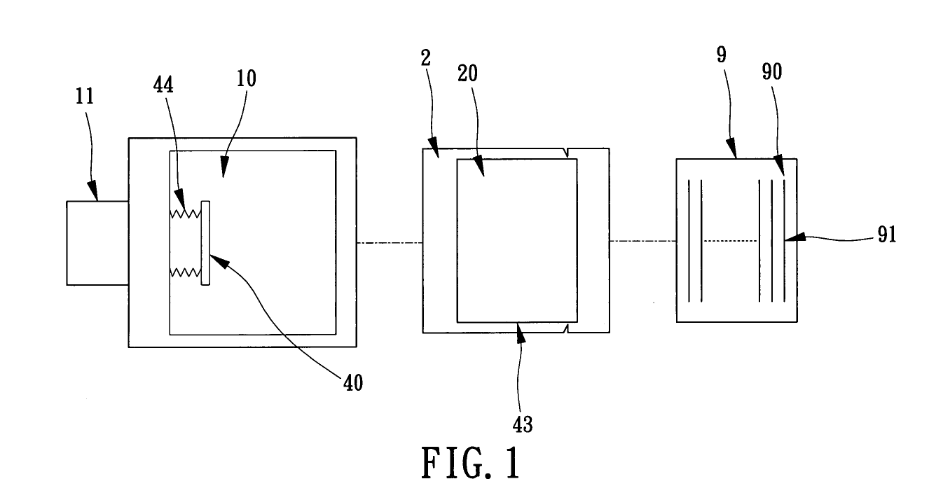

Referring to FIG. 1, the present invention provides an optical compact disk 9 having a thumb-like size, as has a conventional flash disk, and a surface 90 that has a plurality of equidistant lands 91 parallel to one another for storage.

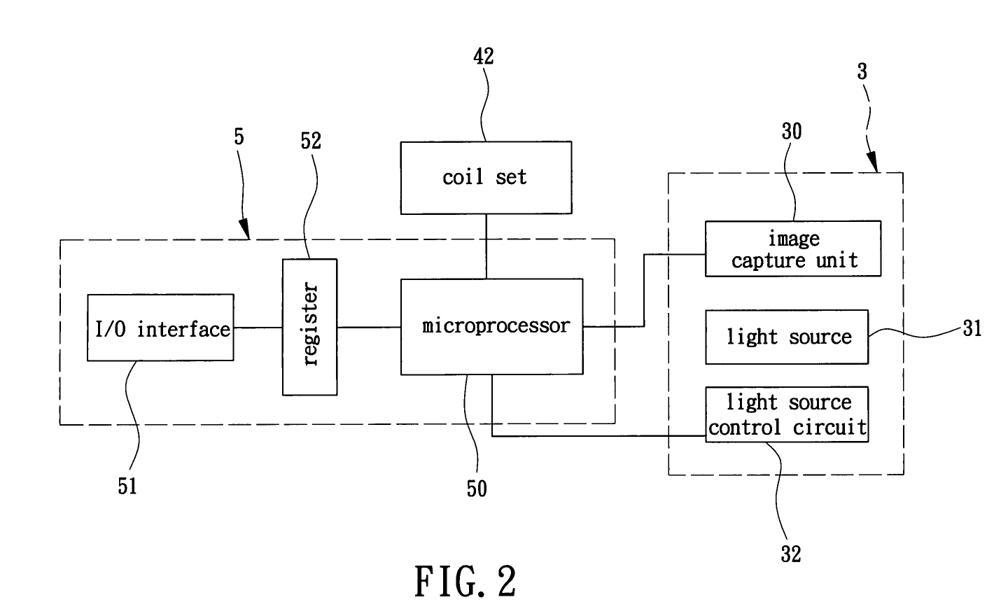

With respect to FIGS. 1 and 2, a first embodiment according to the present invention presents a portable optical compact disk drive that includes a casing 1, a tray 2, an image capture unit 3, a tray orientation mechanism and a control circuit 5.

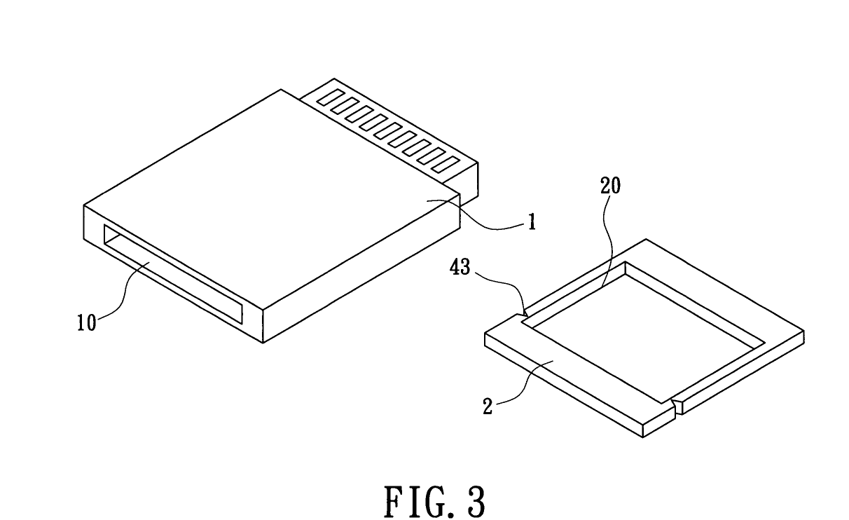

The casing 1 shown in FIG. 3 has a tray-receiving cavity 10 formed therein. The casing 1 includes a connector 11 disposed on an end thereof and electrically connected to a peripheral circuit, an opposing end thereof being free. The tray 2 thus can be accepted in the tray-receiving cavity 10 via the free end of the casing 1, and ejected from and placed into the casing 1, alternatively. The tray 2 has a disk-receiving window 20 formed therein to carry the optical compact disk 9.

The image capture unit 3 is arranged in the casing 1, and records data stored on the surface 90 of the optical compact disk 9 loaded onto the tray 2 while the tray 2 is accepted in the tray-receiving cavity 10. The image capture unit 3 includes a CCD (Charged Coupled Device) or CMOS (Complimentary Metal-Oxide Semiconductor) image sensor 30, a light source 31 and a light source control circuit 32 electrically connecting the light source 31. The CCD or CMOS image sensor 30 is disposed inside the casing 1 and has a plurality of CCD or CMOS cells arranged thereon in an array manner. When the tray 2 is received in the tray-receiving cavity 10, the CCD or CMOS image sensor 30 captures the image information stored on the surface 90 of the optical compact disk 9.

FIG. 5 illustrates a converging member 6 disposed in front of the CCD or CMOS image sensor 30; the converging member 6 is made of transparent materials. The converging member 6 includes a plurality of projective units 60 respectively corresponding to the CCD or CMOS cells and a plurality of partitions 61 separating the projective units 60 from one another.

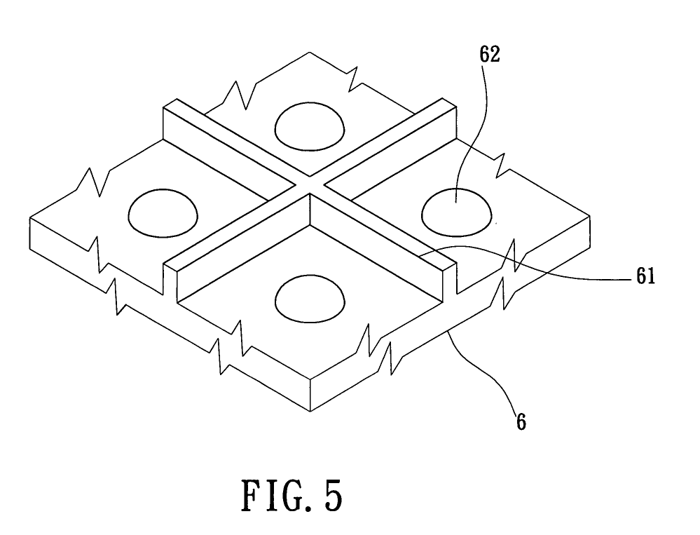

FIG. 6 illustrates another converging member 6′ having the same functions as that in FIG. 5 with the projective units 60, each of different configuration. In particular, the projective units 60 have variable configurations that are not restricted by these embodiments.

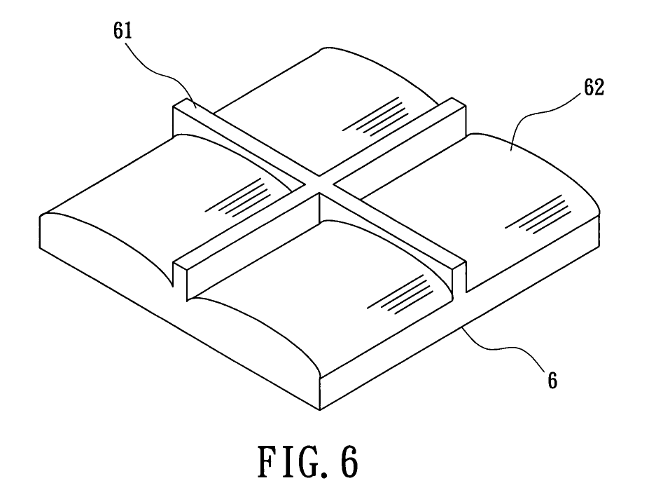

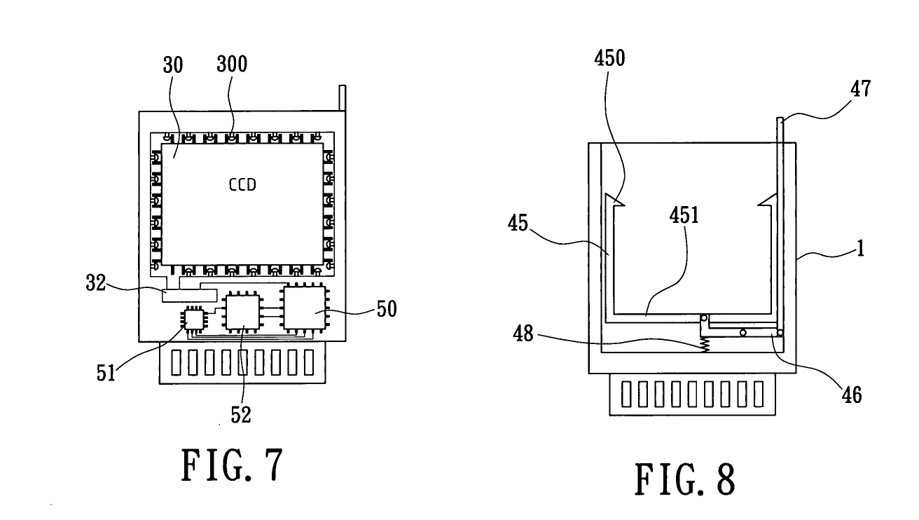

The light source 31 illustrated in FIG. 7 includes a plurality of LEDs 310 surrounding the CCD or CMOS image sensor 30. Each of the LEDs 310 aligns with a respective one of the partitions 61; the CCD or CMOS cells capture the image information provided by the optical compact disk 9, while at least one of the LEDs 310 and the CCD or CMOS image sensor 30 both are driven and at least a respective one of the partitions 61 passes the light simultaneously. Alternatively, the LEDs 310 can be selected to let the partitions 61 pass the light in proper order. In other words, part of the LEDs 310 can be activated, the respective partitions 61 will transmit the light from the LEDs 310, and the CCD or CMOS image sensor 30 can be activated thereby to capture the image information. The image information can thus be captured twice for more precise definition.

The light source 31 can include any lighting member, and is not restricted to LEDs.

The light source control circuit 32 can control the light source 31 to switch the LEDs on or off.

According to FIGS. 1, 2 and 4, the tray orientation mechanism includes a forcing member 40 disposed inside the casing 1, two opposing recesses 43 formed on two lateral sides of the tray 2, respectively, a pair of hooks 41 disposed inside the casing 1 and at two opposing sides in the tray-receiving cavity 10, and a pair of coils sets 42 respectively disposed on the two hooks 41.

The forcing member 40 is disposed inside the casing 1 and opposite the free end of the casing 1, and approaches the free end frequently via a resilient member 44 because the resilient member 44 is pressed while the tray 2 is arranged in the tray-receiving cavity 10. The forcing member 40 contacts the tray 2 simultaneously.

The hooks 41 are disposed inside the casing 1 and at two opposite sides in the tray-receiving cavity 10; the hooks 41 respectively includes two clamping portions 410 extending into the tray-receiving cavity 10. The two clamping portions 410 engage with the two opposing recesses 43, respectively, while the tray 2 is arranged in the tray-receiving cavity 10, so as to avoid the tray 2 departing from the tray-receiving cavity 10 due to the thrust of the forcing member 40. In this embodiment, the hooks 41 are made of metallic materials.

The coil sets 42 are respectively disposed on the two hooks 41, and opposite the clamping portions 410, correspondingly; the coil sets 42 electrically connect the casing 1 so as to develop a magnetic field. The clamping portions 410 are respectively attracted away from the recesses 43; thus, the tray 2 is pushed by the forcing member 40 to leave the tray-receiving cavity 10. The hooks 41 can be made of non-metallic materials, alternatively, under a restriction of a metallic member arranged thereon.

The control circuit 5 is disposed inside the casing 1, electrically connects the image capture unit 3 to receive the image information, and is capable of decoding the image information and transmitting the decoded image information to the peripheral circuit. The control circuit 5 includes a microprocessor 50, a register 52 and an I/O interface 51.

The microprocessor 50 and the register 52 electrically connect the CCD or CMOS image sensor 30 and the light source control circuit 32 of the image capture unit 3, in order to receive the image information, decode the image information and store the decoded image information in the register 52. In addition, the decoded image information is transmitted to the peripheral circuit via the I/O interface 51. After the decoded image information is transmitted to the peripheral circuit, the microprocessor 50 will electrically connect the coil sets 42 to develop a magnetic field to attract the clamping portions 410 of the hooks 41, so as to let the clamping portions 410 depart from the recesses 43. The tray 2 is then pushed by the forcing member 40 to leave the tray-receiving cavity 10.

FIG. 8 shows another embodiment of the tray orientation mechanism according to the present invention. The tray orientation mechanism includes a pair of hooks 45 disposed in the casing 1, a linkage lever 46 pivotally connected in the casing 10, an actuation lever 47 and a resilient member.

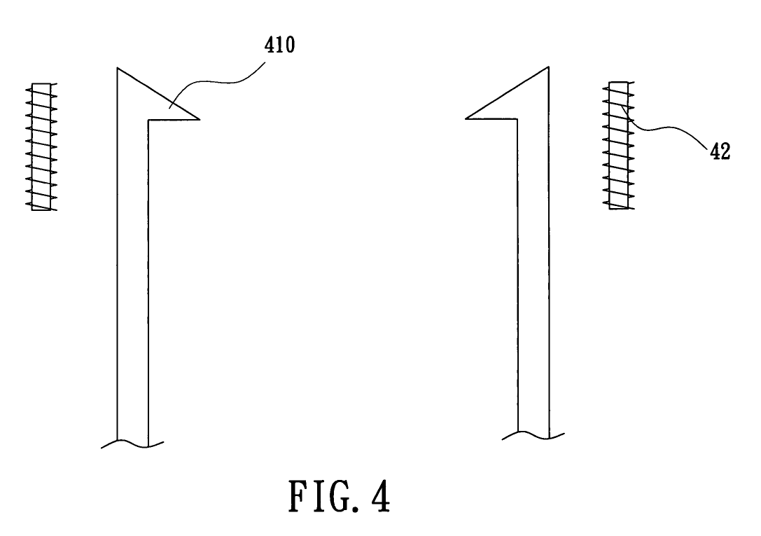

Each of the hooks 45 includes a clamping portion 450, like the first embodiment in FIG. 4, and a pivoting end 451.

The linkage lever 46 has a first end pivotally connecting to the pivoting end 451 and a second end opposite the first end, whereby the linkage lever 46 rotates in a first direction and the clamping portions 450 respectively move towards the two lateral sides of the casing 1; on the contrary, the linkage lever 46 rotates in a second direction that opposes the first direction and the clamping portions 450 move towards each other.

The actuation lever 47 connects the second end of the linkage lever 46, and has an impelling end exposed by the casing 1, in which the impelling end is manipulated and the linkage lever 46 rotates pivotally in the first direction.

The resilient member 48 has an end connecting the first end of the linkage lever 46, and an opposing end connecting the casing 1. The linkage lever 46 is activated by the resilient member 48 frequently, so as to rotate pivotally in the second direction.

Consequentially, the tray 2 is put in the tray-receiving cavity 10, and the clamping portions 450 of the hooks 45 extend to retain against the recesses 43, respectively, in order to prevent the tray 2 from exiting the tray-receiving cavity 10. When the actuation lever 47 is activated, the linkage lever 46 rotates pivotally in the first direction, so that the clamping portions 450 of the hooks 45 move towards the lateral sides of the casing 1, respectively, to escape from the corresponding recesses 43. The tray 2 can thereby be pushed to leave the tray-receiving cavity 10 by the forcing member 40.

The tray orientation mechanisms in FIG. 4 and FIG. 8 can exist at the same time; the tray 2 can be manually or automatically removed from the tray-receiving cavity 10.

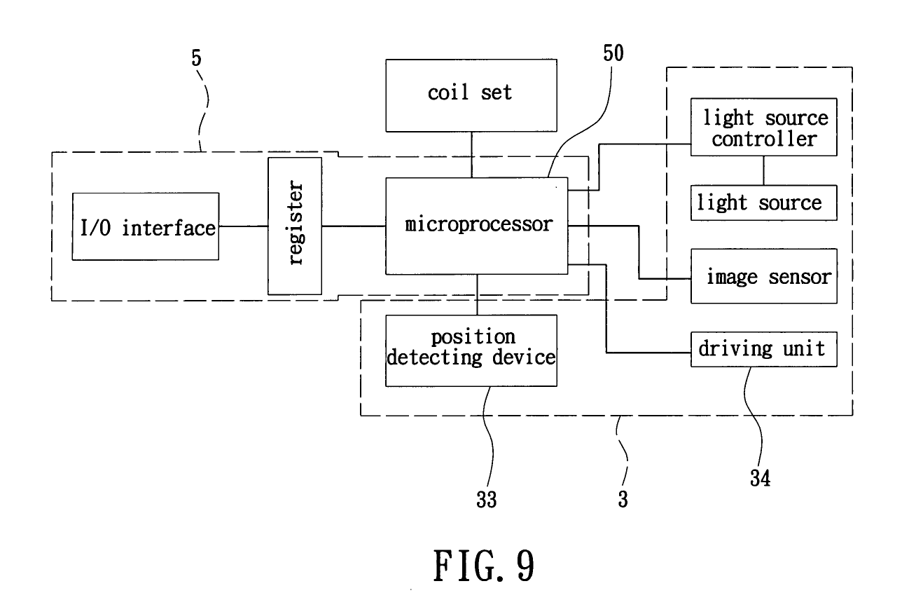

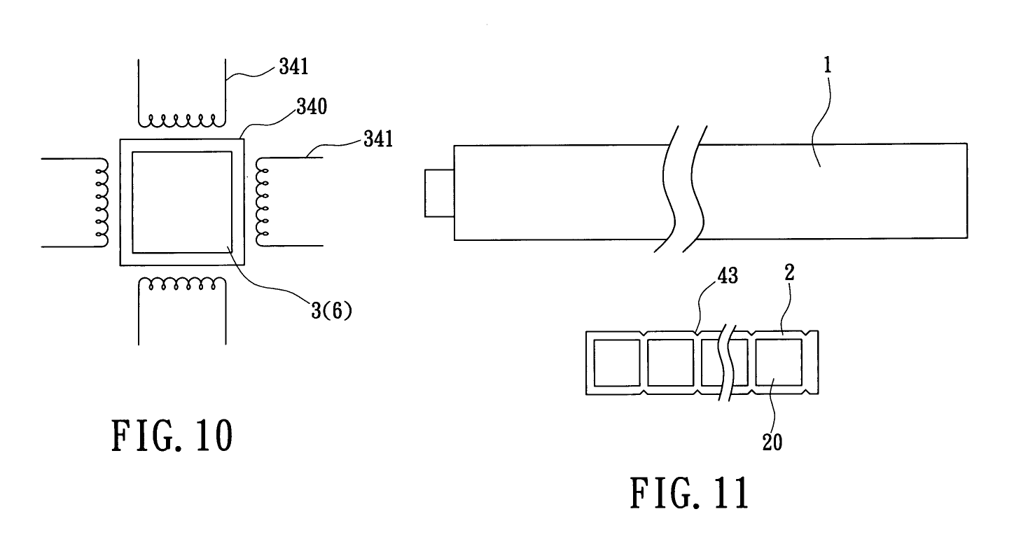

As illustrated in FIGS. 9 and 10, image capture unit 3 can include a position detecting device 33 and a driving unit 34.

The position detecting device 33 electrically connects the microprocessor 50 of the control unit 5. The position detecting device 33 is capable of recognizing if the CCD or CMOS image sensor 30 relates to the optical compact disk 9 within a predetermined position relationship. Therefore, the position detecting device 33 will send a connection signal to the microprocessor 50, when a distance between the CCD or CMOS image sensor 30 and the optical compact disk 9 is out of the predetermined position relationship. The details of the position detecting device 33 are well-known to a person skilled in the art and are not further described here.

The driving unit 31 includes a movable supporting member 340 mounted onto the casing 1 and a plurality of correction coils 341 surrounding the supporting member 340. The quantity of the correction coils 341 in this embodiment is 4. The supporting member 340 is relatively and horizontally movable on the casing 1, left or right, alternatively, and the CCD or CMOS image sensor 30 is disposed on the supporting member 340. The correction coils 341 electrically connect the microprocessor 50, whereby the microprocessor 50 is capable of outputting an action signal by the correction signal from the position detecting device 33 to the correction coils 341. The correction coils 341 are thus driven to develop a magnetic field to move the supporting member 340, the CCD or CMOS image sensor 30 and the optical compact disk 9 away from each other within the predetermined position relationship.

Referring to FIG. 11, in a second embodiment according to the present invention, the tray 2 can include a plurality of disk-receiving windows 20 in order to load multiple optical compact disks 9. The orientation mechanism includes a plurality of recesses formed in two lateral sides of the tray 2, respectively. Each of the recesses 43 is located between the adjacent two of the disk-receiving windows 20, and the optical compact disks 9 can be read one by one from the rightmost thereof.

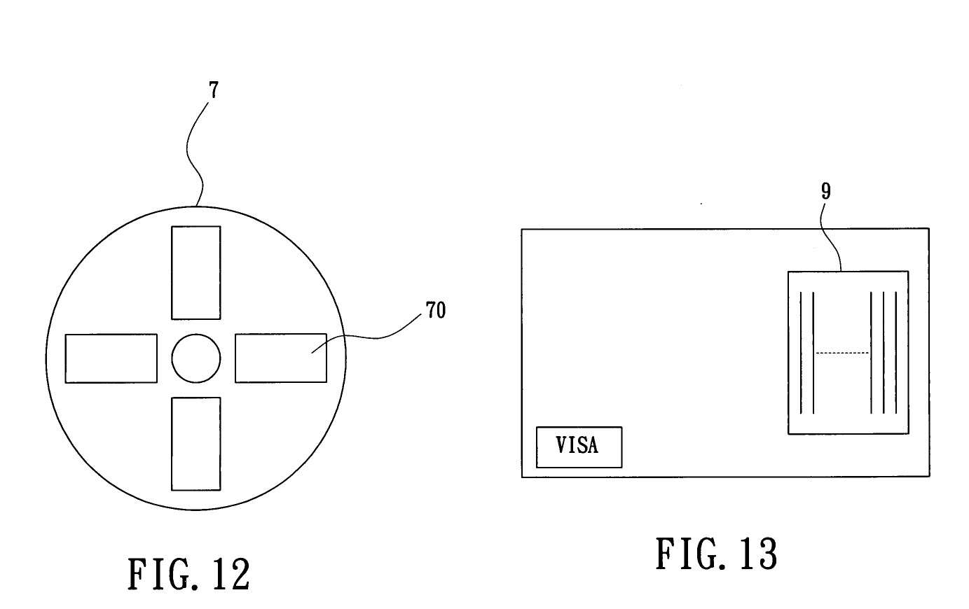

Referring to FIG. 12, a tray 7 adopted for general use is shown. The tray 7 can be put into a conventional tray of a conventional optical compact disk drive; the tray 7 includes a plurality of cavities 70 formed thereon to accept multiple optical compact disks 9 according to the present invention. The optical compact disks 9 can be read or stored by a conventional optical compact disk drive.

With respect to FIG. 13, the optical compact disk 9 can be arranged on a credit card, a business card, an identification card or objects for information storage instead of a magnetic film as currently in use nowadays.

The present invention is also applicable to PDAs, cell phones, digital cameras, notebooks and other IT products.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is invention claimed is:

1. An optical compact disk of thumb-like size and a surface having a plurality of equidistant lands parallel to one another for storage capacity.

2. A portable optical compact disk drive adopted for an optical compact disk, the optical compact disk of thumb-like size and having a surface with a plurality of equidistant lands parallel to one another for data storage, the portable optical compact disk drive comprising:
a casing including a tray-receiving cavity formed therein, a connector disposed on an end thereof and electrically connecting a peripheral circuit, the connecter further having a free opposing end;
a tray accepted in the tray-receiving cavity via the free end of the casing, and alternatively ejected from and placed into the casing, the tray having a disk-receiving window formed therein to carry the optical compact disk;
an image capture unit arranged in the casing, and the image capture unit being capable of recording data stored on the surface of the optical compact disk loaded onto the tray, while the tray is accepted in the tray-receiving cavity; and
a control circuit electrically connecting the image capture unit to receive image information, being capable of decoding the image information and transmitting the decoded image information to the peripheral circuit.

3. The portable optical compact disk drive as claimed in claim 2, wherein the image capture unit includes a CCD (Charged Coupled Device) image sensor having a plurality of CCD cells arranged in an array manner.

4. The portable optical compact disk drive as claimed in claim 2, wherein the image capture unit includes a CMOS (Complimentary Metal-Oxide Semiconductor) image sensor having a plurality of CMOS cells arranged in an array manner.

5. The portable optical compact disk drive as claimed in claim 3, wherein the image capture unit includes a converging member disposed in front of the CCD image sensor, the converging member is made of transparent materials, and the converging member includes a plurality of projective units respectively corresponding to the CCD cells and a plurality of partitions separating the projective units from one another.

6. The portable optical compact disk drive as claimed in claim 5, wherein the image capture unit includes a light source and a light source control circuit electrically connecting the light source, the light source includes a plurality of LEDs surrounding the CCD image sensor, each of the LEDs aligns with a respective one of the partitions, and the CCD cells capture the image information provided by the optical compact disk while at least one of the LEDs and the CCD image sensor is driven and at least a respective one of the partitions passes light simultaneously.

7. The portable optical compact disk drive as claimed in claim 4, wherein the image capture unit includes a converging member disposed in front of the CMOS image sensor, the converging member is made of transparent materials, the converging member includes a plurality of projective units respectively corresponding to the CMOS cells and a plurality of partitions separating the projective units from one another.

8. The portable optical compact disk drive as claimed in claim 7, wherein the image capture unit includes a light source and a light source control circuit electrically connecting the light source, the light source includes a plurality of LEDs surrounding the CMOS image sensor, each of the LEDs is aligned with a respective one of the partitions, and the CMOS cells capture the image information provided by the optical compact disk while at least one of the LEDs and the CMOS image sensor is driven and at least a respective one of the partitions passes light simultaneously.

9. The portable optical compact disk drive as claimed in claim 3, wherein the image capture unit includes a position detecting device and a driving unit, the position detecting device electrically connects a microprocessor of the control unit, and the position detecting device is capable of recognizing if the CCD image sensor relates to the optical compact disk within a predetermined position relationship, whereby the position detecting device is capable of sending a connection signal to the microprocessor when a distance between the CCD image sensor to the optical compact disk is out of the predetermined position relationship, the driving unit includes a movable supporting member mounting onto the casing and a plurality of correction coils surrounding the supporting member, the supporting member is relatively and horizontally movable on the casing, either left or right, the CCD image sensor is disposed on the supporting member, and the correction coils electrically connect the microprocessor, whereby the microprocessor is capable of outputting an action signal by the correction signal from the position detecting device to the correction coils, wherein the correction coils are driven to develop a magnetic field to move the supporting member, and the CCD image sensor and the optical compact disk are separated from each other within the predetermined position relationship.

10. The portable optical compact disk drive as claimed in claim 4, wherein the image capture unit includes a position detecting device and a driving unit, the position detecting device electrically connects a microprocessor of the control unit, and the position detecting device is capable of recognizing if the CMOS image sensor relates to the optical compact disk within a predetermined position relationship, whereby the position detecting device is capable of sending a connection signal to the microprocessor when the a distance between the CMOS image sensor and the optical compact disk is out of the predetermined position relationship, the driving unit includes a movable supporting member mounting onto the casing and a plurality of correction coils surrounding the supporting member, the supporting member is relatively and horizontally movable on the casing, either left or right, the CMOS image sensor is disposed on the supporting member, and the correction coils electrically connect the microprocessor, whereby the microprocessor is capable of outputting an action signal by the correction signal from the position detecting device to the correction coils, wherein the correction coils are driven to develop a magnetic field to move the supporting member, and the CMOS image sensor and the optical compact disk are separated from each other within the predetermined position relationship.

11. The portable optical compact disk drive as claimed in claim 2, further including a tray orientation mechanism for maintaining the tray arranged in the disk-receiving window of the casing, the tray orientation mechanism including:
at least two opposing recesses formed in two lateral sides of the tray, respectively;
a forcing member disposed inside the casing and opposing the free end of the casing, wherein the forcing member approaches the free end frequently via a resilient member, because the resilient member is pressed while the tray is arranged in the tray-receiving cavity and the forcing member contacts the tray simultaneously;
a pair of hooks disposed inside the casing and at two opposing sides in the tray-receiving cavity, the hooks respectively including two clamping portions extending into the tray-receiving cavity, whereby the two clamping portions engage with the two opposing recesses, respectively, while the tray is arranged in the tray-receiving cavity, so as to avoid the tray departing from the tray-receiving cavity due to the thrust of the forcing member; and
a pair of coil sets respectively disposed on the two hooks and opposite the clamping portions correspondingly, the coil sets electrically connecting the control circuit to develop a magnetic field, whereby the clamping portions are respectively attracted away from the recesses, the tray being pushed by the forcing member to leave the tray-receiving cavity.

12. The portable optical compact disk drive as claimed in claim 2, further including a tray orientation mechanism for maintaining the tray arranged in the disk-receiving window of the casing, the tray orientation mechanism including:
a pair of hooks disposed in the casing, each of the hooks including a clamping portion and a pivoting end;
a linkage lever pivotally connecting in the casing and having a first end pivotally connecting to the pivoting end and a second end opposite the first end, whereby the linkage lever rotates in a first direction, the clamping portions respectively move towards the two lateral sides of the casing and the linkage lever rotates in a second direction opposite the first direction, and the clamping portions move towards each other;
an actuation lever connecting the second end of the linkage lever and having an impelling end exposed by the casing, wherein when the impelling end is manipulated, the linkage lever rotates pivotally in the first direction; and
a resilient member having an end connecting the first end of the linkage lever and an opposing end connecting the casing, wherein the linkage lever is activated by the resilient member frequently to move in the second direction.

13. The portable optical compact disk drive as claimed in claim 2, wherein the control circuit includes a microprocessor electrically connecting the image capture unit, the microprocessor being capable of receiving image information, decoding the image information, and transmitting the decoded image information to the peripheral circuit via an I/O interface.

14. The portable optical compact disk drive as claimed in claim 6, wherein the control circuit includes a microprocessor, a register and an I/O interface, the microprocessor and the register electrically connect the CCD image sensor and the light source control circuit of the image capture unit to receive the image information, decode the image information and store the decoded image information in the register, and the decoded image information is transmitted to the peripheral circuit via the I/O interface.

15. The portable optical compact disk drive as claimed in claim 6, wherein the control circuit includes a microprocessor, a register and an I/O interface, the microprocessor and the register electrically connect the CMOS image sensor and the light source control circuit of the image capture unit to receive the image information, decode the image information and store the decoded image information in the register, and the decoded image information is transmitted to the peripheral circuit via the I/O interface.

16. A tray receivable in a conventional tray of a conventional optical compact disk drive, and comprising at least a cavity wherein the optical compact disk as claimed in claim 1 is placed.
